(19) United States
(12) Patent Application Publication
(10) Pub. No.: US 2009/0207438 A1
(43) Pub. Date: Aug. 20, 2009

(54) Print system

(75) Inventor: Fusayuki Fujita, Osaka (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/321,955

(22) Filed: Jan. 26, 2009

(30) Foreign Application Priority Data
Feb. 14, 2008 (JP) 2008-033242

(51) Int. Cl. G06F 3/12

(52) U.S. Cl. 358/1.15

(57) ABSTRACT

A print system according to an embodiment of the present invention includes a plurality of client computers, one or a plurality of print servers that store jobs received from the client computers in a memory unit and process the jobs, a plurality of printers that receive a job from the print servers and perform print processing and a network that the client computers, the print servers and the printers are connected to. On receipt of a job from the client computer, in order to notify that the job received from the client computer is stored in the memory unit, the print server transmits job information of the received job to the printers on the network.

This application claims priority under 35 U.S.C. § 119(a) on Patent Application No. 2008-033242 filed in Japan on Feb. 14, 2008, the entire contents of which are herein incorporated by reference.

### BACKGROUND OF THE INVENTION

1. Field of the Invention

The present invention relates to a print system.

2. Technical Field

As a conventional print system, a print system is known in which one or a plurality of print servers store jobs received from a plurality of client computers via a network in a memory unit and process the jobs, and a plurality of printers receive the jobs from the print servers and perform print processing.

Note that the conventional print system includes the plurality of client computers, the plurality of print servers that process a request for printing print data from the plurality of client computers, the plurality of printers connected to the print servers, and a local area network to which the plurality of client computers and the plurality of print servers are connected. The conventional print system is configured to cause one of the plurality of print servers that starts operating first to manage information concerning a print request output to the print server and other print servers, and to cause a printer connected to a specific print server to perform print processing when the print request is made to the specific print server (e.g. see JP H11-161446A).

However, such a conventional print system did not allow a user to store a job related to that user (own job) in a print server. Accordingly, the user did not have a means to confirm the job related to that user from a printer on the network with which the user wants to print. Besides, the user was unable to select/input a desired job from a plurality of jobs and print the selected/input job automatically.

### SUMMARY OF THE INVENTION

The present invention has been conceived in view of such circumstances, and it is an object of the present invention to provide a print system that enables a user to learn job information related to that user from any one of the printers on a network.

A print system according to the present invention includes a plurality of client computers, one or a plurality of print servers that store jobs received from the client computers in a memory unit and process the jobs, a plurality of printers that receive a job from the print servers and perform print processing and a network that the client computers, the print servers and the printers are connected to. On receipt of a job from the client computer, in order to notify that the job received from the client computer is stored in the memory unit, the print server transmits job information of the received job to the printers on the network.

With this configuration, a user can learn job information related to the user from any one of the printers on the network.

Furthermore, in the print system according to the present invention, the printer is provided with an authentication unit for performing user authentication and a display unit, and when the authentication unit confirms permission of use for a user operating the printer, the printer may be configured to receive job information from the print server and to display the job information on the display unit.

In the print system according to the present invention, the printer may be configured to display job information received from the print server on the display unit for selectable input, and when a job is selected/input from the job information displayed on the display unit, the printer may be configured to receive the selected/input job from the print server and to automatically print the job.

With this configuration, a job is selected/input by a user from job information displayed on the display unit of the printer. Subsequently, the selected/input job is received from the print server, and printing of the job is performed. Accordingly, a user is able to print a job related to that user with any one of the printers on the network.

In the print system according to the present invention, the print server, along with transmitting to the printer a selected/input job in the printer, may be configured to delete the selected/input job from the memory unit and to notify that the selected/input job has been deleted to other printers on the network.

With this configuration, a user can learn from printers other than the printer in which selection/input was made that the print server deleted the selected/input job in the printer.

Moreover, in the print system according to the present invention, when a selected/input job is printed, the printer may be configured to notify that the job has been printed to the client computer via the network.

With this configuration, a user can learn from the client computer that the job selected/input in the printer has been printed.

In the print system according to the present invention, when printing a selected/input job is stopped, the printer may be configured to display that printing the selected/input job has been stopped on the display unit and to notify that printing of the selected/input job has been stopped to the client computer via the network

With this configuration, a user can learn from the printer or the client computer that printing of the selected/input job has been stopped.

Note that a case where there is no recording medium such as paper available for printing (i.e. a paper-out condition), a case where a failure occurs or the like can be exemplified as a case where printing of a job is stopped. In addition, for instance, if at least one of the plurality of printers performs print processing using toner, a case where there is no toner available for printing (i.e. a toner-out condition) or the like can be exemplified.

In the print system according to the present invention, job information displayed on the display unit may be displayed as a job list showing job IDs corresponding to user IDs.

With this configuration, a job list corresponding to user IDs can be displayed on the display unit. Consequently, a user can select/input a job related to that user more easily.

In this case, it is preferable that, in the job list showing job IDs corresponding to user IDs displayed on the display unit, the printer displays a job list showing a job ID corresponding to a user ID of a user permitted by the authentication unit with emphasis.

With this configuration, a job list of a user permitted by the authentication unit can be displayed distinctly from a job list of users other than the permitted one. As a result, a user can select/input a job related to that user more easily.

Note that “user ID” according to the present invention is a code such as numbers or symbols assigned to a corresponding user and denotes an identification code for identifying a user. In addition, “job ID” according to the present invention is a code such as numbers or symbols assigned to a corresponding job and denotes an identification code for identifying a job.

### BRIEF DESCRIPTION OF THE DRAWINGS

FIG. 1 is a system block diagram schematically showing a print system according to an embodiment of the present invention.

FIG. 2 is a block diagram showing one example of a schematic configuration of a client computer in the print system shown in FIG. 1.

FIG. 3 is a block diagram showing one example of a schematic configuration of a print server in the print system shown in FIG. 1.

FIG. 4 is a diagram schematically showing one example of a data configuration constituted of print job information and a print job stored in a print job storage unit of the print server shown in FIG. 3.

FIG. 5 is a block diagram showing one example of a schematic configuration of a printer in the print system shown in FIG. 1.

FIG. 6 is a diagram schematically showing one example of a list display of print job information displayed on a display unit of the printer shown in FIG. 5.

FIG. 7 is a flow chart showing one example of an operation flow of the client computer in the print system shown in FIG. 1.

FIG. 8 is a flow chart showing one example of an operation flow of the print server in the print system shown in FIG. 1.

FIG. 9 is a flow chart showing one example of an operation flow of the printer in the print system shown in FIG. 1.

### DESCRIPTION OF THE PREFERRED EMBODIMENTS

Hereinafter, an embodiment of the present invention will be described with reference to the drawings. Note that the following embodiment is an exemplary embodiment of the present invention and does not limit the technical scope of the present invention.

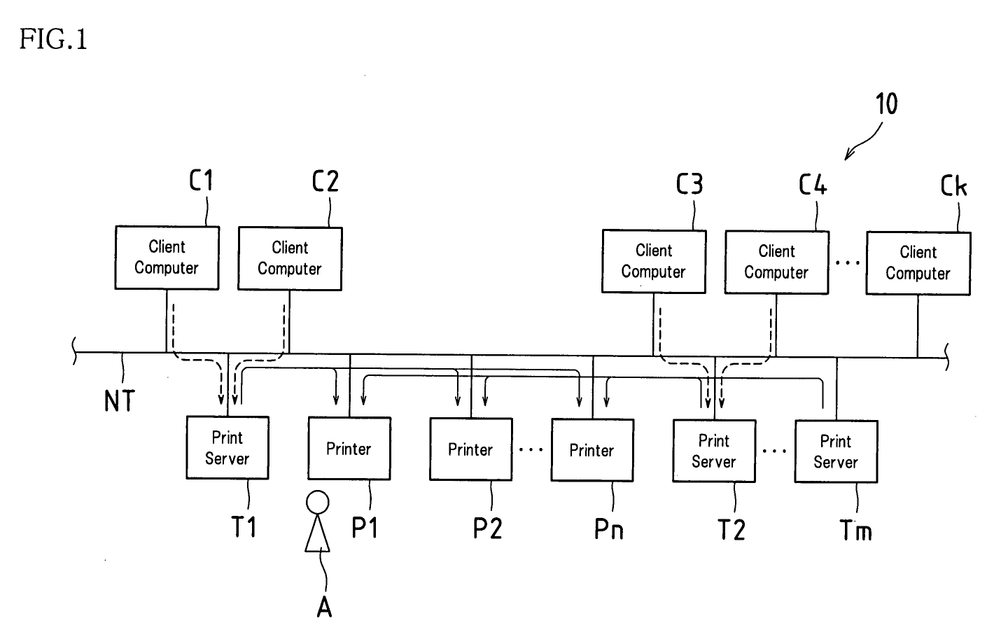

FIG. 1 is a system block diagram schematically showing a print system according to an embodiment of the present invention.

A print system 10 shown in FIG. 1 includes a network NT, a plurality of client computers C1 to Ck (k is an integer of 2 or more) connected to the network NT, one or a plurality of print servers T1 to Tm (m is an integer of 1 or more) that are connected to the network NT, store a job received from the client computers C1 to Ck via the network NT in respective memory units 202 (not shown in FIG. 1, see FIG. 3 described below) and process the job, and a plurality of printers P1 to Pn (n is an integer of 2 or more) that are connected to the network NT, receive a job from the print servers T1 to Tm via the network NT and perform print processing.

Furthermore, when receiving a job (e.g. print data) and its job information (e.g. user ID and job ID) from any one of the client computers C1 to Ck via the network NT, the print servers T1 to Tm store the job received from the client computers in the memory unit 202 and transmit the job information of the job to all the printers P1 to Pn on the network NT via the network NT in order to notify that the job is stored in the memory unit 202.

As a result, a user can learn job information related to that user from any one of the printers P1 to Pn on the network NT.

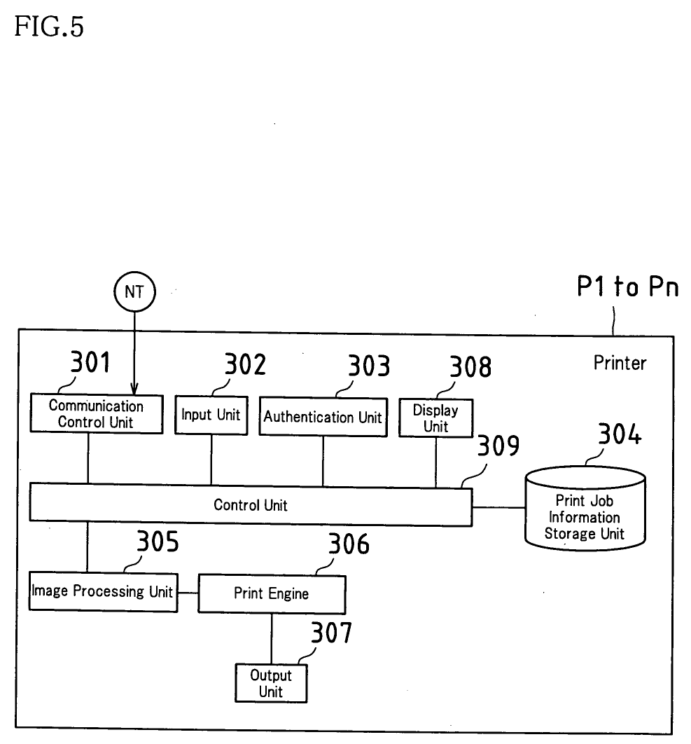

Moreover, the printers P1 to Pn each have an authentication means that performs user authentication and a display unit 308 (see FIG. 5 described below). Specifically, the printers P1 to Pn each have an authentication unit 303 (see FIG. 5) as an authentication means to perform user authentication in addition to the display unit 308.

When the authentication unit 303 confirms permission of use for a user operating the printers P1 to Pn (e.g. user A operating the printer P1), the printers P1 to Pn receive job information transmitted from the print servers T1 to Tm via the network NT and display the job information on the display unit 308. Note that, out of the job information transmitted from the print servers T1 to Tm via the network NT, the printers P1 to Pn may receive only job information related to the user authenticated by the authentication unit 303 and display the job information on the display unit 308.

Under the print system 10 with such a configuration, one of the print servers T1 to Tm (e.g. print server T1) receives a job and its job information from the client computers C1 to Ck (e.g. client computers C1 and C2).

When receiving a job and its job information, after storing the job and the job information in the memory unit 202, the print servers T1 to Tm notify the printers P1 to Pn that the job is stored in the memory unit 202 by transmitting the job information to all the printers P1 to Pn via the network NT.

On the other hand, when operated by a user for printing a job related to that user (own job), the user authentication is performed by the authentication unit 303, and the printers P1 to Pn display the job information on the display unit 308 after receiving the job information from the print servers T1 to Tm via the network NT.

More specifically, the print servers T1 to Tm consist of a plurality of print servers, and each print server manages an arbitrary number of client computers divided from the client computers C1 to Ck. In the example shown in FIG. 1, the print server T1 is dedicated for the client computers C1 and C2, handling the client computers C1 and C2, while the print server T2 is dedicated for the client computers C3 and C4, handling the client computers C3 and C4.

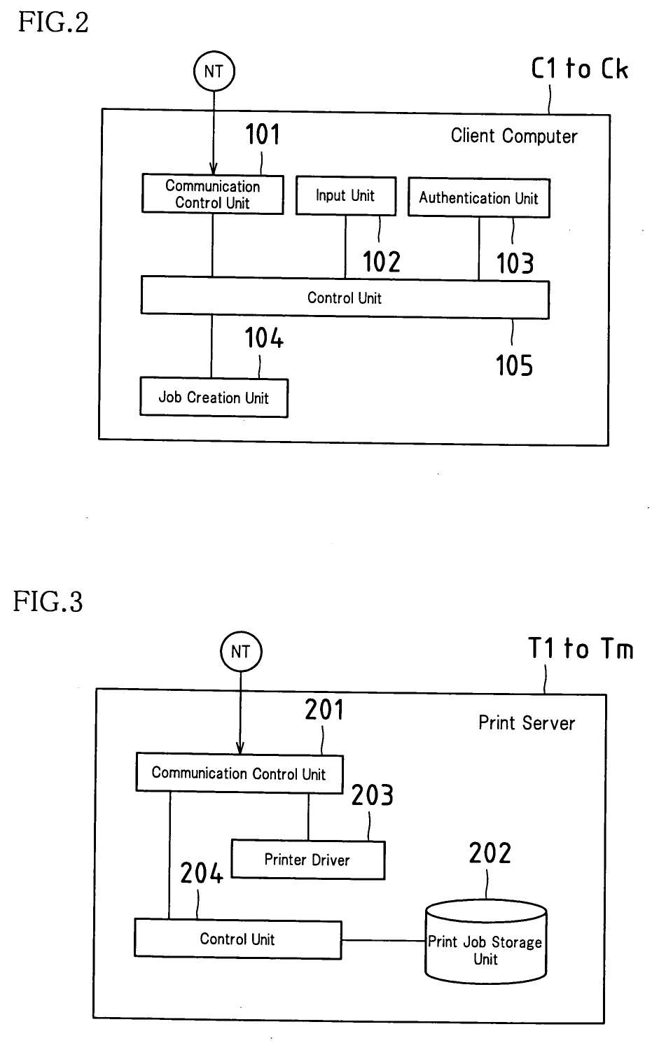

FIG. 2 is a block diagram showing one example of a schematic configuration of the client computers C1 to Ck in the print system shown in FIG. 1. As shown in FIG. 2, the client computers C1 to Ck are provided with a communication control unit 101, an input unit 102, an authentication unit 103 as an authentication means, a print job creation unit 104 and a control unit 105.

The communication control unit 101 connects the client computer to a print server handling the client computer via the network NT. The input unit 102 includes an operation unit with which a user can perform an input operation. The authentication unit 103, in which a user ID and its corresponding password are registered in advance, confirms whether or not the user having performed an operation is registered by comparing a user ID and a password input by the user with the input unit 102 with a user ID and its corresponding password registered in advance. The print job creation unit 104 creates a job (e.g. print job created using application software). Note that print data created using application software for a word processor and print data created using application software for a spreadsheet program can be exemplified as a job created using application software. The control unit 105 controls the entire client computer by giving instructions and commands to the communication control unit 101, the input unit 102, the authentication unit 103 and the print job creation unit 104. Furthermore, the control unit 105 transmits a job created by the print job creation unit 104 along with a user ID of which a user is authenticated to the print servers T1 to Tm handling that client computer via the network NT. In the example shown in FIG. 1, the client computers C1 and C2 transmit a created job along with a user ID to the print server T1 handling the client computers C1 and C2, while the client computers C3 and C4 transmit a created job along with a user ID to the print server T2 handling the client computers C3 and C4.

FIG. 3 is a block diagram showing one example of a schematic configuration of the print servers T1 to Tm in the print system shown in FIG. 1. As shown in FIG. 3, the print servers T1 to Tm are provided with a communication control unit 201, a memory unit (here, serves as a print job storage unit, hereinafter referred to as print job storage unit) 202, a printer driver 203 and a control unit 204.

The communication control unit 201 connects the print server to a client computer handled by the print server and the printers P1 to Pn via the network NT. The print job storage unit 202 stores a job and job information received from a client computer that the print server handles. The printer driver 203 converts a job selected/input by the user with the printers P1 to Pn that are a source of a print request into data capable of being printed. The control unit 204 controls the entire print server by giving instructions and commands to the communication control unit 201 and the print job storage unit 202.

Furthermore, the control unit 204 receives a job and a corresponding user ID from a client computer that the print server handles via the network NT and stores the job and the user ID in the print job storage unit 202. Specifically, the control unit 204 receives a job and a corresponding user ID from a client computer that the print server handles, assigns a job ID to the received job, and stores the job and the corresponding user ID and job ID (i.e. job information) in the print job storage unit 202.

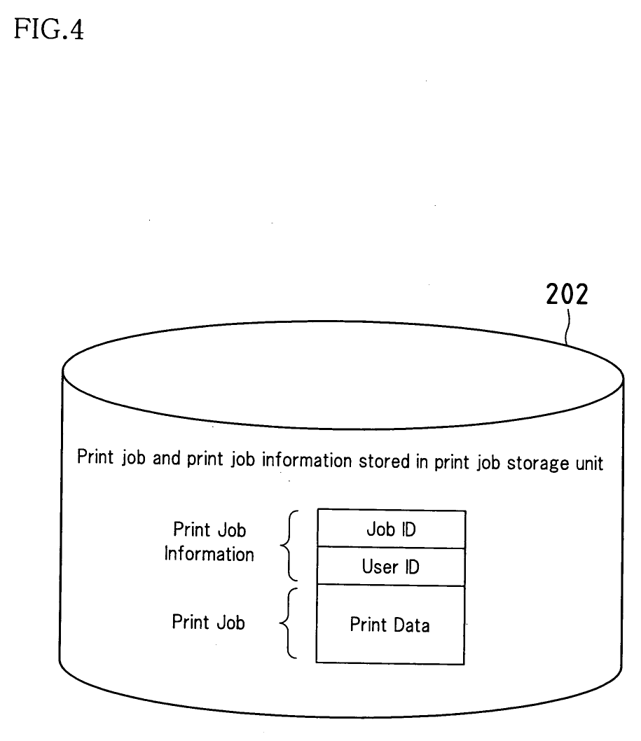

FIG. 4 is a diagram schematically showing one example of a data configuration constituted of print job information and a print job stored in the print job storage unit 202 of the print server shown in FIG. 3. More specifically, the control unit 204 manages user IDs of users, job IDs of print jobs related to users and print data that constitutes a print job. That is, the control unit 204 stores print data assigned a job ID in association with a user ID in the print job storage unit 202 in order of receipt.

Moreover, the control unit 204 notifies the printers P1 to Pn that the job is stored in the print job storage unit 202 by transmitting via the network NT job information from a client computer that the print server handles to all the printers P1 to Pn on the network NT. In the example shown in FIG. 1, the print server T1 receives a job (see dashed arrow) from the client computers C1 and C2 that are handled by the print server T1 and transmits job information (see solid arrow) to all the printers P1 to Pn on the network NT in order to notify that the job is stored.

Furthermore, the control unit 204, along with transmitting the job via the network NT to the printer (e.g. P1) in which the job is selected/input by the user, deletes the job that has been transmitted from the print job storage unit 202. In addition, the control unit 204 notifies that the job has been deleted to the printers (e.g. P2 to Pn) other than the printer (e.g. P1) in which the job was selected/input via the network NT.

FIG. 5 is a block diagram showing one example of a schematic configuration of the printers P1 to Pn in the print system shown in FIG. 1. As shown in FIG. 5, the printers P1 to Pn are provided with a communication control unit 301, an input unit 302, an authentication unit (one example of an authentication means) 303, a print job information storage unit 304 as a memory unit, an image processing unit 305, a print engine 306, an output unit 307, a display unit 308 and a control unit 309.

The communication control unit 301 connects the printer to the print servers T1 to Tm via the network NT. The input unit 302 includes an operation unit with which a user can perform an input operation. The authentication unit 303, in which a user ID and its corresponding password are registered in advance, confirms whether or not the user having performed an operation is registered by comparing a user ID and a password input by the user with the input unit 302 with a user ID and its corresponding password registered in advance. The print job information storage unit 304 stores job information received from the print servers T1 to Tm.

The image processing unit 305 converts a job to be printed into data capable of being printed when printing with the print engine 306. The print engine 306 prints data converted by the image processing unit 305 onto a recording medium such as a recording paper. The output unit 307 discharges the recording medium printed by the print engine 306. The display unit 308 displays various items of display information transmitted from the control unit 309.

Here, the display unit 308 is a display panel device, and the input unit 302 is disposed on the display surface of the display panel device, being a touch panel device configured to enable a user to perform an input operation from the display surface. Moreover, an operation panel unit can be configured with the display panel device and the touch panel device disposed on the display surface.

The control unit 309 controls the entire printer by giving instructions and commands to the communication control unit 301, the input unit 302, the authentication unit 303, the print job information storage unit 304, the image processing unit 305 and the display unit 308.

Furthermore, the control unit 309, on receipt of a job print request from a user authenticated by an authentication operation (log-in operation), transmits an inquiry (i.e. request for transmitting a user ID and a job ID) to the print servers T1 to Tm via the network NT. Subsequently, the control unit 309 receives job information from the print servers T1 to Tm via the network NT and stores the job information in the print job information storage unit 304. On the other hand, the control unit 309 displays a list of the stored job information on the display unit 308.

Specifically, the control unit 309 displays a list of job information (e.g. a job ID corresponding to a user ID) received from the print servers T1 to Tm via the network NT on the display unit 308 so as to enable a user to select/input.

According to the present embodiment, the job information displayed on the display unit 308 is displayed as a list of a job ID corresponding to a user ID.

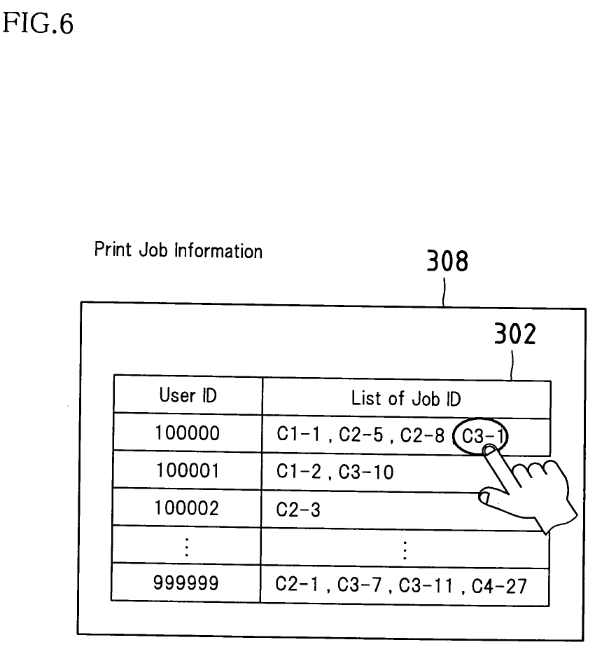

FIG. 6 is a diagram schematically showing one example of a list display of print job information displayed on the display unit 308 of the printer shown in FIG. 5.

As shown in FIG. 6, a list of user IDs of users including those permitted (logged in) by the authentication unit 303 and all job IDs related to each user corresponding to the user ID are displayed on the display unit 308 of the printers P1 to Pn. According to an example shown in FIG. 6, job IDs “C1-1”, “C2-5”, “C2-8” and “C3-1” related to a user having a user ID “100000” are displayed; job IDs “C1-2” and “C3-10” related to a user having a user ID “100001” are displayed; a job ID “C2-3” related to a user having a user ID “100002” is displayed; and job IDs “C2-1”, “C3-7”, “C3-11” and “C4-27” related to a user having a user ID “999999” are displayed. Note that, out of the symbols of a job ID, a symbol that comes before the “-” (hyphen) denotes a code of a client computer with which a job was created, and a symbol that comes after the “-” (hyphen) denotes a serial number of a job created with the client computer. In addition, according to the example shown in FIG. 6, a state of a user selecting/inputting “C3-1” with the input unit 302 on the display surface of the display unit 308 with a finger is shown.

Moreover, in a job list of job IDs corresponding to each user ID displayed on the display unit 308, the control unit 309 displays a job list of a job ID corresponding to a user ID of a user permitted (logged in) by the authentication unit 303 with emphasis by, for instance, changing colors, high lightening, boldfacing or blinking.

Furthermore, if one job in the job list of job information displayed on the display unit 308 is selected/input by a user, the control unit 309 receives the job from a print server that stores the job via the network NT and automatically prints the job.

In the printers P1 to Pn with such a configuration, job information is read out from the print job information storage unit 304 that stores job information from the print servers T1 to Tm, and a list of the read job information is displayed on the display unit 308 for selectable input. Next, when a user authenticated by the authentication unit 303 selects/inputs one job in a job list displayed on the display unit 308 with the input unit 302, data of the selected/input job is downloaded from a print server that stores the job data via the network NT. On completion of this downloading, the downloaded job is converted into data capable of being printed in the image processing unit 305 and after being printed automatically by the print engine 306, the printed recording medium is discharged onto the output unit 307.

Furthermore, when the job selected/input by the user is printed, the control unit 309 notifies that the job has been printed to the client computer that created the job via the network NT.

Moreover, when printing of the job selected/input by the user is stopped, the control unit 309 displays that printing of the job has been stopped on the display unit 308. Consequently, even when a printer printing the job goes into a state where printing is stopped due to, for instance, toner running out while printing, the user can learn that printing has been stopped and can deal with such a case.

Specifically, at least one of the printers P1 to Pn performs print processing using toner. When toner runs out while printing, the control unit 309 of the printer performing print processing using toner stops printing the job selected/input by a user from a job information list displayed on the display unit 308 and displays that printing of the job has been stopped on the display unit 308. In addition, the control unit 309 notifies that printing of the job has been stopped to a client computer that created the job via the network NT. As a result, even when a printer printing the job goes into a state where printing is stopped due to, for instance, toner running out while printing, the user can learn that printing has been stopped and can take fast and appropriate steps toward the printer.

[Regarding Print Processing Flow of a Print System]

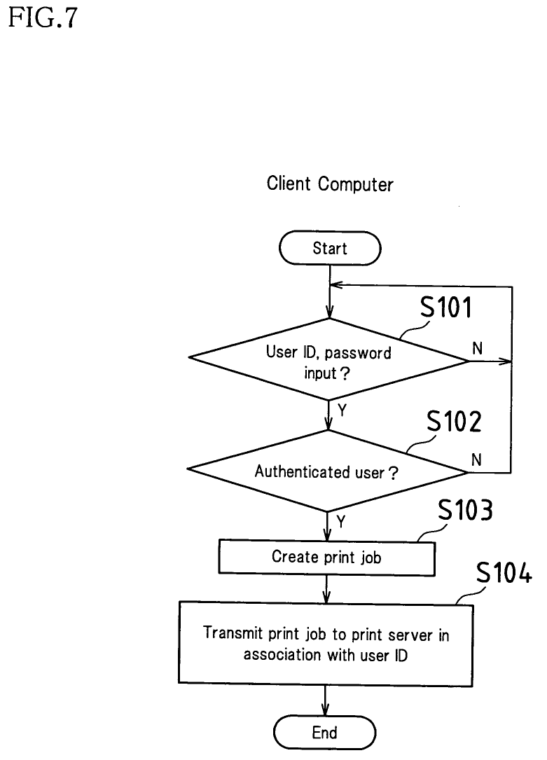

Next, print processing flow of the print system 10 shown in FIG. 1 will be described. FIGS. 7 to 9 are flow charts showing an example of an operation flow of the client computers C1 to Ck, the print servers T1 to Tm and the printers P1 to Pn in the print system 10 shown in FIG. 1, respectively.

The present embodiment will be described by taking an example case where a user A creates a job (hereinafter referred to as print job) with the client computer C1 and prints the job, using a user ID and a job ID as print job information of the print job with the printer P1. Moreover, description will be given, assuming that the printer P1 performs print processing using toner, the input unit 302 is a touch panel device 302, and the display unit 308 is a display panel device 308.

[Regarding Operation of a Client Computer]

As shown in FIG. 7, in step S101, the client computer C1 waits until a user ID and a password are input for user authentication with the input unit 102 (step S101: N). By the user A inputting a user ID and a password (step S101: Y), the authentication unit 103 authenticates a user ID of the user A (step S102). If the user A is not confirmed (step S102: N), the procedure returns to step S101. If the user A is confirmed (logs in) (step S102: Y), the procedure proceeds to step S103.

Consequently, the user A who logged in creates a print job at the print job creation unit 104 (e.g. print data created using spreadsheet software) (step S103). After completion of the print job, the user A transmits the print job in association with the user ID to the print server T1 via the network NT in order to cause the printer that the user wishes to use to print (step S104).

[Regarding Operation of a Print Server]

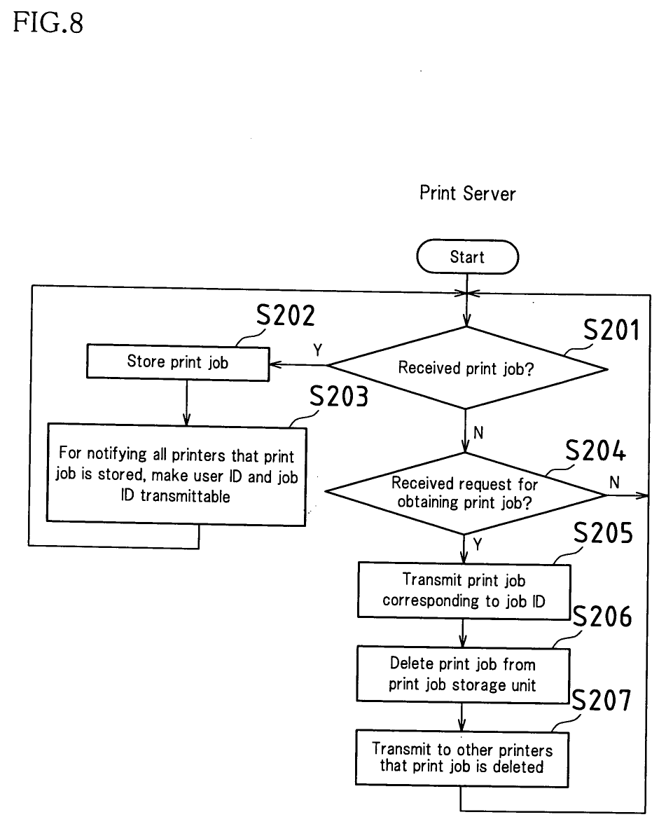

As shown in FIG. 8, the print server T1 judges whether or not a print job transmitted from the client computer C1 via the network NT is received (step S201). On receipt of the print job (step S201: Y), the print server T1 assigns a job ID to the received print job and stores the print job and the corresponding job ID and user ID (i.e. print job information) in the print job storage unit 202 (step S202). In order to notify all the printers P1 to Pn on the network NT that the print server T1 holds the print job, the user ID and the job ID are made transmittable (step S203), and the procedure returns to step S201.

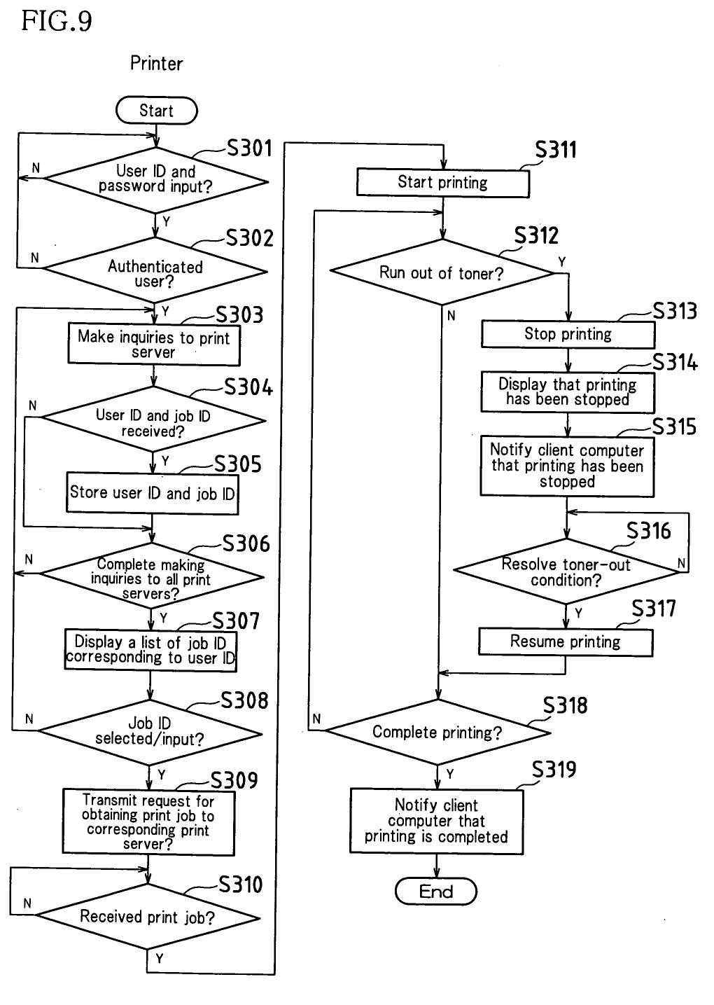

On the other hand, in step S201, when not receiving a print job from the client computer C1 (step S201: N), as described below with reference to FIG. 9, the print server T1 judges whether or not a print request is made via the network NT from the printer P1 in which the user A selected/input one print job from that user's own job list (step S204). If the print request is not made (step S204: N), the procedure returns to step S201. On the other hand, if the print request is made (step S204: Y), the print server T1 transmits a print job corresponding to the job ID selected/input in the printer P1 operated by the user A to the printer P1 via the network NT (step S205).

When the print job is transmitted in step S205, and downloading to the printer in which the print job is selected/input is completed, in step S206, the print job is deleted from the print job storage unit 202 so as to secure memory capacity of the print job storage unit 202. On completion of deleting this print job, in step S207, the print server T1 notifies via the network NT that the print job is deleted to printers other than the printer P1 that made the print request, and the procedure returns to step S201.

Note that, on receipt of a notification of deletion of the print job via the network NT, printers P2 to Pn, i.e. printers other than P1 in which the user A made a print request, update data in the print job storage unit 202 so as to delete the job information related to the user A, which is not shown in a flow chart of FIG. 9 described below.

[Regarding an Operation of a Printer]

As shown in FIG. 9, in step S301, the printer P1 waits until a user ID and a password are input from the touch panel device (the input unit) 302 for user authentication (step S301: N) and by the user A inputting a user ID and a password (step S301: Y), the authentication unit 303 confirms whether or not the user A is able to use the printer P1 (step S302). In this step S302, if the authentication unit 303 judges that the user A is unable to use the printer P1 (step S302: N), the procedure returns to step S301, however if the authentication unit 303 judges that the user A is able to use the printer P1 (step S302: Y), the procedure proceeds to step S303.

When permission for the user A to use the printer P1 is confirmed (step S302: Y), the printer P1 makes an inquiry to the print servers T1 to Tm via the network NT (i.e. request for transmitting a user ID and a job ID) (step S303) and judges whether or not the user ID and the corresponding job ID are received (step S304). In step S304, if the user ID and the job ID are not received (step S304: N), the procedure proceeds to step S306, however if the user ID and the job ID are received (step S304: Y), the printer P1 stores the received user ID and job ID in a print job storage unit 304 (step S305), and the procedure proceeds to step S306. Note that the print servers T1 to Tm that received an inquiry from the printer via the network NT in step S303 transmit the user ID and job ID that were made transmittable in step S203 described above to the printer P1 via the network NT.

Next, the printer P1 judges whether or not the inquiry to all the print servers is completed (step S306). If not completed (step S306: N), the procedure returns to step S303. If completed (step S306: Y), the printer P1 displays a list of job IDs corresponding to user IDs on the display panel device (the display unit) 308 (step S307). At this time, the job list of the user A displayed on the display panel device 308 is displayed with emphasis (e.g. in red) so as to be easily distinguishable from job lists of users other than the user A (e.g. in white).

In a state where a job list displayed on the display panel device 308 is not selected/input, the procedure returns to step S303 (step S308: N), however when the user A selects/inputs one of the job IDs in the job list displayed on the display panel device 308 (a job ID “C3-1” is touched in the example shown in FIG. 6) (step S308: Y), the print server T1 storing a print job of the selected/input job ID is requested to transmit the print job (step S309), and the printer P1 receives the print job and waits until downloading is completed (step S310: N).

In step S310, on receipt of the print job from the print server T1 and completion of downloading the print job (step S310: Y), printing is started (step S311).

If the printer P1 runs out of toner while printing in this step (step S312: Y), printing of the print job selected/input with the touch panel device 302 is stopped (step S313). Subsequently, it is displayed on the display panel device 308 that printing the selected/input print job has been stopped (step S314). Moreover, the printer P1 notifies via the network NT that printing of the selected/input print job has been stopped to the client computer C1 that created the print job (step S315). As a result, even when the user A returns after performing a print operation to the client computer C1 that created the print job, the user A can be aware of a problem of the printer P1 running out of toner. Consequently, the user A is able to take a measure to resolve the problem of the printer P1 running out of toner immediately.

Thereafter, the printer P1 waits until the measure to resolve the problem of toner running out has been taken (step S316: N). If it is judged that the measure to resolve the problem of toner running out has been taken (step S316: Y), printing is resumed (step S317), and the procedure proceeds to step S318. At this time, the printer P1 may display that printing of the print job has been resumed on the display panel device 308, and additionally, may notify via the network NT that printing of the print job has been resumed to the client computer C1 that created the print job. Note that the case where toner runs out is described here as a case where printing is stopped, however even when a paper-out condition or a failure occurs, similar measures can be taken.

In step S318, the printer P1 judges whether or not printing of the print job is completed. If printing is not completed (step S318: N), the procedure proceeds to step S312. If printing is completed (step S318: Y), the printer P1 notifies via the network NT that printing has been completed to the client computer C1 that created the print job (step S319), and processing is ended.

Note that although print processing flow shown in FIGS. 7 to 9 are described with the client computer C1, the print server T1 and the printer P1 taken as examples, other client computers, print servers and printers can surely process in a similar manner.

The present invention may be embodied in various other forms without departing from the spirit or essential characteristics thereof. The embodiment disclosed in this application is to be considered in all respects as illustrative and not limiting. The scope of the invention is indicated by the appended claims rather than by the foregoing description, and all modifications or changes that come within the meaning and range of equivalency of the claims are intended to be embraced therein.

What is claimed is:

1. A print system comprising:
a plurality of client computers;
one or a plurality of print servers that store jobs received from the client computers in a memory unit and process the jobs;
a plurality of printers that receive a job from the print servers and perform print processing; and
a network that the client computers, the print servers and the printers are connected to,
wherein on receipt of a job from the client computer, in order to notify that the job received from the client computer is stored in the memory unit, the print server transmits job information of the received job to the printers on the network.

2. The print system according to claim 1, wherein the printer is provided with an authentication unit for performing user authentication and a display unit, and when the authentication unit confirms permission of use for a user operating the printer, the printer receives job information from the print server and displays the job information on the display unit.

3. The print system according to claim 2, wherein the printer displays job information received from the print server on the display unit for selectable input, and when a job is selected/input from the job information displayed on the display unit, the printer receives the selected/input job from the print server and automatically prints the job.

4. The print system according to claim 3, wherein the print server, along with transmitting to the printer a selected/input job in the printer, deletes the selected/input job from the memory unit and notifies that the selected/input job has been deleted to other printers on the network.

5. The print system according to claim 3, wherein, when a selected/input job is printed, the printer notifies that the job has been printed to the client computer via the network.

6. The print system according to claim 4, wherein, when a selected/input job is printed, the printer notifies that the job has been printed to the client computer via the network.

7. The print system according to claim 3, wherein, when printing a selected/input job is stopped, the printer displays that printing the selected/input job has been stopped on the display unit and notifies that printing the selected/input job has been stopped to the client computer via the network

8. The print system according to claim 4, wherein, when printing a selected/input job is stopped, the printer displays that printing the selected/input job has been stopped on the display unit and notifies that printing the selected/input job has been stopped to the client computer via the network

9. The print system according to claim 5, wherein, when printing a selected/input job is stopped, the printer displays that printing the selected/input job has been stopped on the display unit and notifies that printing the selected/input job has been stopped to the client computer via the network

10. The print system according to claim 6, wherein, when printing a selected/input job is stopped, the printer displays that printing the selected/input job has been stopped on the display unit and notifies that printing the selected/input job has been stopped to the client computer via the network

11. The print system according to any one of claims 2 to 10, wherein job information displayed on the display unit is displayed as a job list showing job IDs corresponding to user IDs.

12. The print system according to claim 11, wherein, in the job list showing job IDs corresponding to user IDs displayed on the display unit, the printer displays a job list showing a job ID corresponding to a user ID of a user permitted by the authentication unit with emphasis.
